(19) United States
(12) Patent Application Publication
(10) Pub. No.: US 2016/0311358 A1
(43) Pub. Date: Oct. 27, 2016

(54) Van lift system and method of use

(71) Applicant: Larry Alexander, Indianapolis, IN (US)

(72) Inventor: Larry Alexander, Indianapolis, IN (US)

(21) Appl. No.: 14/545,348

(22) Filed: Apr. 27, 2015

(51) Int. Cl. B60P 1/54

(52) U.S. Cl. CPC B60P 1/5423

(57) ABSTRACT

A van lift or crane system and method of use which includes enhanced strengthening components to safely carry more weight without risk of collapse of the overall unit. The system includes angled connector sections and supporting braces to allow a slide unit to move in and out of the van cargo area with minimum stress on the crane or lift. The method of use includes installing the lift into a van cargo area in a highly cost-effective manner. The unit may be utilized for rear door loading or for van side door loading as desired by the user.

### BACKGROUND AND OBJECTS OF THE INVENTION

The present invention is generally related to the crane or lift arts and is specifically designed for use in the cargo compartments of large or small transport vans.

The closest prior art related to this invention is U.S. Pat. No. 7,134,831 issued to Risser on Nov. 14, 2006.

The Risser patent teaches the use of a bridge crane in the rear of a transport truck. The Risser is highly subject to load and support failure which can be a very damaging and costly situation in the truck crane arts.

Accordingly, it is an object of the invention to set forth a loading system and method for large or small vans which provides greatly enhanced strength and sturdiness in the art.

It is a further object of the present invention to demonstrate a van loading or lift system which may be easily and efficiently installed in the rear portion of a transport van.

It is also an object of the invention to show a lift having enhanced strength features such as angled upper portions and attached braces which are critical to the overall support and stability of the lift or crane.

It is a still further object to show a lift or product moving crane which may be utilized in aircraft systems and ocean-going vessels by reason of the enhanced crane or lift strength.

These and other objects and advantages of the improved lift or crane will be apparent to those of skill in the art from the invention description which follows.

### SUMMARY OF THE INVENTION

The van lift structure is utilized for loading and unloading vans of various sizes. The design also has many advantageous uses for aircraft cargo loading and unloading and ocean-going ships and related vessels.

The lift or crane includes rear and forward leg portions each of which have an angled element attached thereto.

Braces are attached to the angled elements to support C-shaped slide elements.

A tray having a winch attached thereto is moved within the C-shaped slide elements.

The tray has a specific reinforced design to handle higher loads and allows the winch to be moved to various advantageous positions.

The design further includes crossbar elements attached to the angled portions.

### BRIEF DESCRIPTION OF THE DRAWING FIGURES

FIG. 1 shows a top schematic view of a van-type vehicle in which is placed a lift or crane unit having having special strengthening and reinforcing properties.

FIG. 2 is an end schematic view of the van cargo compartment showing a portion of the crane or lift and the features thereof which render the lift to be highly useful in the art.

FIG. 3 is a schematic view of the overall lift showing the angled upper portions and the support braces attached thereto, along with the lengthwise connecting bars and the C-shaped channel sections.

FIG. 4 is an enlarged view of the upper left-hand portion of FIG. 2 and clearly shows the angled upper portion with the brace attached thereto and the C-shaped section further attached to the brace.

FIG. 5 is a top schematic view of the slidable tray used to carry winch means for a load to be loaded or unloaded. The arrows show the advantageous degrees of motion of the overall system.

### FULL DESCRIPTION OF A PREFERRED EMBODIMENT

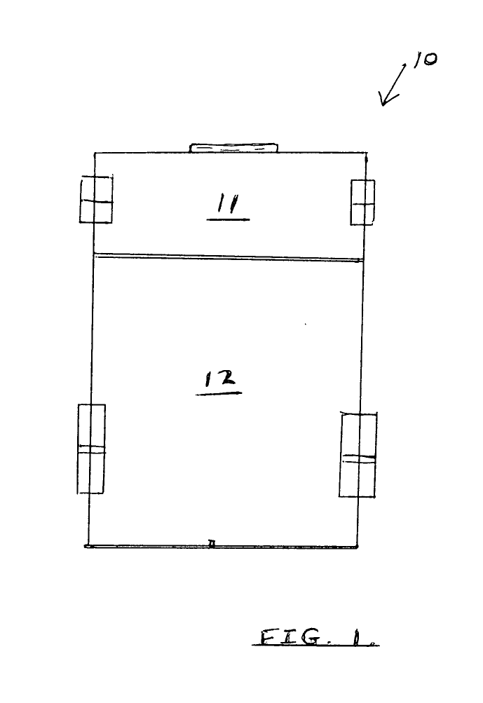

FIG. 1 is a top schematic view of a van 10 having a passenger area 11 and a cargo compartment 12.

The van lift or crane is placed in the cargo compartment 12.

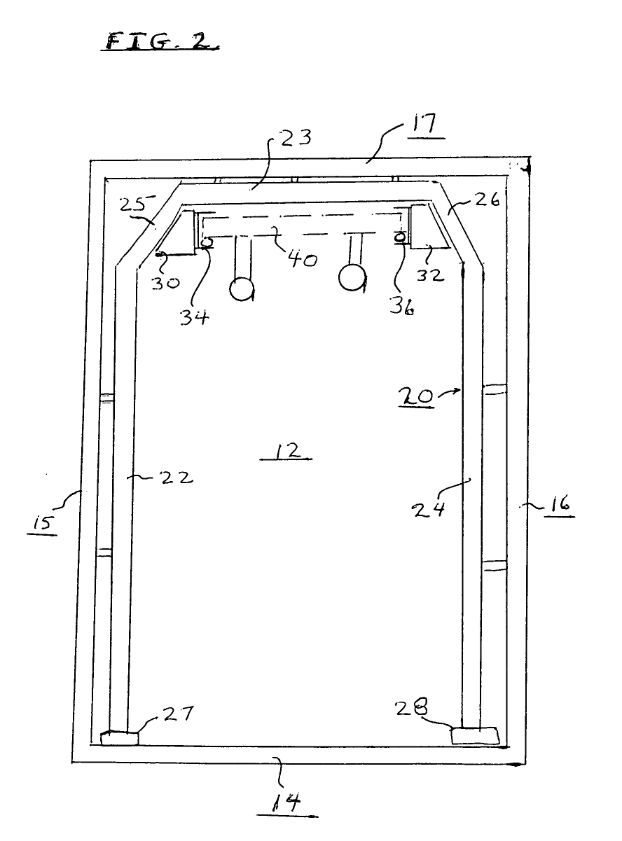

Referring to FIG. 2, an end schematic view of the cargo compartment 12, the cargo area 12 has a lower wall 14, side walls 15 and 16, and top wall 17.

FIG. 2 further shows a crane or lift 20 having lateral or side support legs 22 and 24 and an upper bridging or cross bar 23.

The lift 20 further includes angled connector bars 25 and 26. In the area of the angled connector bars are supporting and reinforcing elements 30 and 32. Attached to the supporting elements 30 and 32 are generally C-shaped slide units 34 and 36.

A slidable tray and weight moving unit 40 is further shown in FIG. 2 and has at least one winch element as shown.

The angled and bracing units 25, 26, 30 and 32 are critical to the enhanced overall strength of the lift or crane unit.

As further shown in FIG. 2, a slidable tray 40 is positioned within the C-shaped slide units. The particular critical elements of the slidable tray 40 will be described hereinafter.

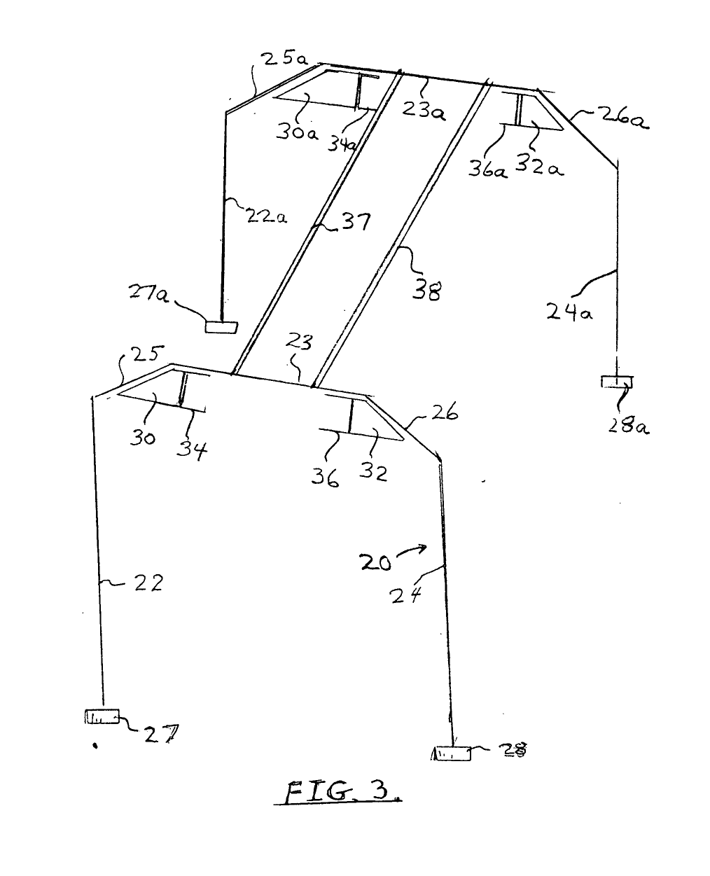

Referring to the schematic view of FIG. 3, the lift 20 is shown as an overall rack device to support the loading and unloading process.

FIG. 3 shows the rear legs, crossbar and angled portions at numerals 22, 23, 24, 25 and 26. The front legs, i.e. in the front area of the van, front crossbar and angled portions are indicated at numerals 22a, 23a, 24a, 25a and 26a.

The C-shaped slide support units are also shown schematically at numerals 34, 36, 34a and 36a.

Numerals 37 and 38 show two length-running bar units which extend between the crossbar units 23 and 23a to provide overall connecting support for the lift or rack unit 20.

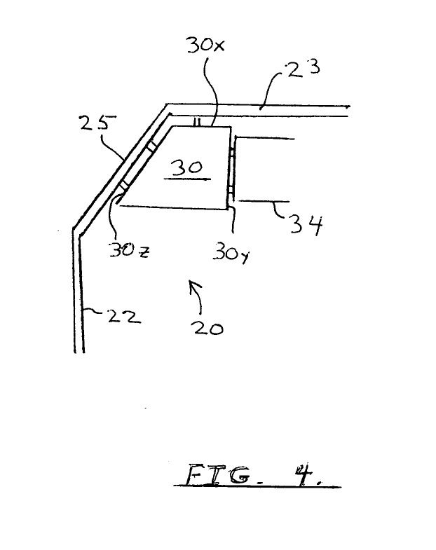

FIG. 3 also shows the reinforcing brace units at numerals 30, 32, 30a and 32a. As noted, such brace units are important to the overall structure and are more fully described with reference to FIG. 4.

FIG. 4 shows an enlarged view of the upper left-hand corner of FIG. 2 to illustrate how the brace element 30 and the other brace elements of the system interact with the angled portions and the C-shaped slide elements to provide maximum load-carrying ability and highest system strength.

FIG. 4 shows brace 30 having a top horizontal edge 30x affixed to the crossbar 23. Brace 30 further has a vertical edge 30y which is attached to the C-shaped slide element 34. Brace 30 also has an angled edge 30z which is attached to the angled portion 25 of the overall lift or rack 20. The specific brace combination with other system elements thus provides less bending stress when the sliding tray is extended.

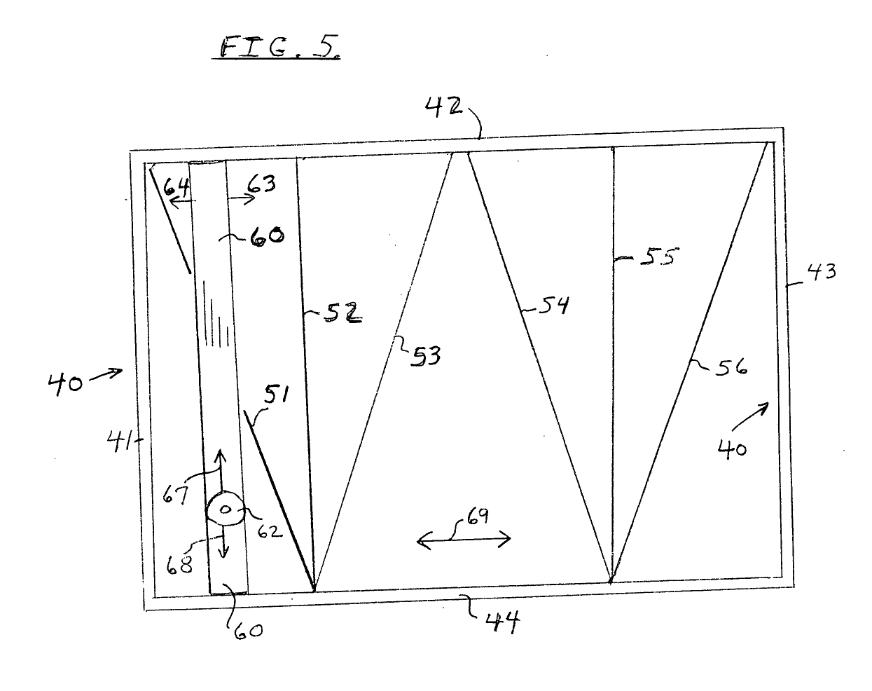

FIG. 5 is a top view of the slidable tray 40 having walls 41-44. Angled support struts 51, 52, 53 and 54, 55, 56 extend between 42 and 44. Such angled positioning has been found to reduce bending stress.

A winch carrier 60 is movable along tray 40 via hydraulic means indicated by arrows 63 and 64. The winch itself 62 is movable laterally along the winch carrier via hydraulic means indicated by arrows 67 and 68, thus providing for maximum versatility in load position at drop-off.

As further shown in FIG. 5, the overall tray 40 is movable to the left and right via hydraulic means indicated schematically by arrows 69.

Critical aspects of the invention include the overall shape of tray 40 in combination with angled support struts 51-56 and movable winch support 60 and winch 62. Other critical aspects of the invention include the angled portions 25 and 26 and the particular supporting shape of braces 30 and 32 to provide maximum support for the C-shaped sections 34 and 36. Foot supports for the overall structure are shown at 27, 28, 27a and 28a.

While a particular structure and loading system have been shown and described, it is intended herein to broadly claim all equivalent structures and systems which would reasonably occur to those of skill in the art.

The invention is further defined by the claims which are included herewith.

The method steps used in practice of the invention are as follows:
A) installing a crane or lift in the rear cargo compartment of a van,
B) providing that said lift have angled upper support means for improved system strength,
C) providing that said lift further include brace means for enhanced system strength.
D) providing a tray means for moving slidably along said lift.

I claim:

1. A lift or crane for use in combination with a van or other product transport device, wherein said lift includes two legs positioned at a rear portion of said van,
said lift further including two further leg portions at a forward portion of the van transport area,
wherein the upper portions of said legs have angled portions attached thereto and wherein the angled portions have a crossbar extending there-between,
wherein the angled portions each have a brace attached thereto,
wherein each brace has a C-shaped slide element attached thereto and wherein the C-shaped slides have a sliding tray positioned therein,
wherein said sliding tray is movable from a forward location of said van to a rearward location of said van to provide means for moving cargo to be unloaded or loaded,
wherein said crossbar elements are connected by at least two lengthwise bar units.

2. The lift or crane of claim 1 wherein the brace element has a top horizontal edge affixed to the crossbar, a vertical edge which is attached to the C-shaped slide element and an angled edge which is attached to the angled portion of the overall lift of rack.

3. The lift or crane of claim 1 wherein the slidable tray includes angled support strut means for reducing bending stress when the tray is carrying a load.

4. The lift or crane of claim 1 wherein the tray includes a winch carrier, the winch carrier being movable along the tray and wherein the winch itself is movable laterally along the winch carrier.

5. A method of using a lift or crane in the rear cargo portion of a van comprising the steps of:
A) providing that the van lift includes angled upper support means for improved system strength,
B) providing that said lift further includes brace means attached to said angled support,
C) providing a tray means for moving slidably along said lift,
D) providing that said tray slides within C-shaped sections attached to said brace.

6. A subcombination lift including the following elements in a corner portion thereof:
a) an angled upper support means between a leg element and a crossbar,
b) a brace means attached to said angled upper support means,
c) a C-shaped section attached to said brace to provide support means for a slideable tray.
